(19) United States
(12) Patent Application Publication
(10) Pub. No.: US 2006/0042062 A1
(43) Pub. Date: Mar. 2, 2006

(54) Tool for disconnection of tubing from a coupling

(75) Inventor: Kevin L. Tally, Clarinda, IA (US)

Correspondence Address: BANNER & WITCOFF, LTD., TEN SOUTH WACKER DRIVE, SUITE 3000, CHICAGO, IL, 60606, US

(73) Assignee: Lisle Corporation, Clarinda, IA (US)

(21) Appl. No.: 11/032,842

(22) Filed: Jan. 11, 2005

Related U.S. Application Data
(60) Provisional application No. 60/605,027, filed on Aug. 27, 2004.

(51) Int. Cl. B23P 19/04

(52) U.S. Cl. 29/237

(57) ABSTRACT

A tool for uncoupling tubular connections includes a pair of bifurcated arms joined together by an integral, arcuate, bridge member wherein the bifurcated arms of the tool include sections which are arranged at an obtuse angle with respect to each other, the active end of the tool including couple disengaging semi-cylindrical sectors or heads.

### CROSS REFERENCE TO RELATED APPLICATION

This is a utility application based upon provisional application entitled Tool for Disconnection of Tubing from Coupling, Ser. No. 60/605,027 filed Aug. 27, 2004 for which priority is claimed and which is incorporated herewith by reference.

### BACKGROUND OF THE INVENTION

In a principal aspect the present invention relates to a tool, and a set of tools, which may be utilized to disconnect coupled tubing of the type commonly used in the automotive industry.

In U.S. Pat. No. 5,455,995 entitled “Tool for Uncoupling Quick Connect Tubular Couplings”, there is disclosed a tool which is useful to disconnect tubular coupling constructions, for example, couplings of the type disclosed in U.S. Pat. No. 4,055,359. Also disclosed in U.S. Pat. No. 4,055,359 is a tool which may be used for disconnecting such coupling arrangements. The invention claimed in U.S. Pat. No. 5,455,995 is an improved disconnect tool which is useful for disconnecting couplings of various sizes.

More recently in U.S. Pat. No. 6,195,862 B1 entitled “Tubular Disconnect Tool with Angled Semi-Annular Heads” there is disclosed another type of tool which is useful for disconnecting or decoupling tubing connections. U.S. Pat. No. 6,195,862 B1 is incorporated herewith by reference. In this patent, there is disclosed the utilization of first and second pivotally joined arms which are biased by an elastic member to cause the two arms to come together so that the semi-cylindrical head of each arm may fit over a tube and be engaged with a tube coupler in a manner which will effect decoupling. This patent teaches that there should be an angular relationship between the decoupling tube engagement end of the tool and the pivoting, connection leg of the tool. While such a device has worked successfully, there are environmental problems which potentially affect this tool. That is, an elastic member such as a rubber band is utilized to cause the separate jaws or legs of the tool to be biased toward one another. The rubber tends to degrade in a workplace environment and, as a result, the tool may be difficult to manipulate or may fail to achieve its intended function. For these and other reasons, an improved decoupling tool has been sought.

### SUMMARY OF THE INVENTION

Briefly, the present invention comprises a tubing disconnect tool which is made from a molded plastic material, such as acetal polymeric or resin, and which is comprised of a single molded element incorporating a pair of elastically connected, bifurcated arms with tube engaging distal or decoupling ends. The opposite end of the tool comprises a generally arcuate, integral, elastic biasing member which connects the bifurcated arms. Each arm is articulated at an included obtuse angle with respect to the decoupling end.

Thus, it is an object of the invention to provide an improved tube decoupling tool.

It is a further object of the invention to provide an integrally molded, unitary decoupling tool.

Another object of the invention is to provide a decoupling tool which may be manufactured in any one of a number of sizes wherein the tool includes an end for engaging the tubing that is to be decoupled arranged on arms that are at an angle with respect to an opposite end wherein an elastic biasing link or element connects the arms, said biasing element being integrally molded with the biasing arms.

Another object of the invention is to provide an improved decoupling tool which may be easily color coded.

Another object of the invention is to provide a decoupling tool which may be manufactured in a manner which provides for an elastic connection between the arms of the tool wherein the elasticity is adjustable depending upon the size of the tool and other factors associated with the use of the tool.

A further object of the invention is to provide a set of decoupling tools in combination with a tool support and storage device.

These and other objects, advantages and features of the invention will be set forth in the detailed description which follows.

### BRIEF DESCRIPTION OF THE DRAWING

In the detailed description which follows, reference will be made to the drawing comprised of the following figures:

FIG. 1 is a first isometric view of the tool of the invention;

FIG. 2 is an isometric view of the bottom side of the tool of FIG. 1;

FIG. 3 is a bottom auxiliary plan view of the tool of FIG. 1;

FIG. 4 is a bottom plan view of the tool of FIG. 1;

FIG. 5 is a right hand end view of the tool of FIG. 4;

FIG. 6 is a side view of the tool of FIG. 4;

FIG. 7 is another isometric view of the tool of the invention and

FIG. 8 is a view of the tool as it is utilized.

FIG. 9 is an elevation of support member or holder for a set of decoupling tools;

FIG. 10 is a top plan view of the holder of FIG. 9; and

FIG. 11 is an elevation of the combination of a set of decoupling tools mounted on the holder of FIG. 9.

### DESCRIPTION OF THE PREFERRED EMBODIMENT

Referring to the figures, the tool of the invention is comprised of an integrally molded element, molded, for example, from an elastic material such as Delrin® acetal resin, a trademarked product of E.I. Dupont de Nemours & Co. Typically, the tool is made in a series of different sizes. For example, six different sizes may be made to comprise a set. Thus, each size of the tool of the invention is sized so that each tool has the capability of being utilized with specifically sized tubing and the associated tubing coupler. That is, each tool may be utilized to effect disconnection of a particular diameter sized tubing from connection with other tubing or a port in a device compatible with the particular tubing.

Thus, each of the tools of the invention includes a first generally semi-cylindrical head member; such as head member 20, and a second opposed generally semi-cylindrical, mirror image head member 22 arranged on the distal ends, respectively, 24 and 26 of elongate arms 28 and 30. The arms 28 and 30 include a first end run or arcuate section 32 and a second end run or arcuate section 34 respectively. Runs 32, 34 are planar, arcuate elements and are generally transverse to a center line axis 36 of the semi-cylindrical sections 20 and 22. Runs 32, 34 surround the sections 20, 22 respectively.

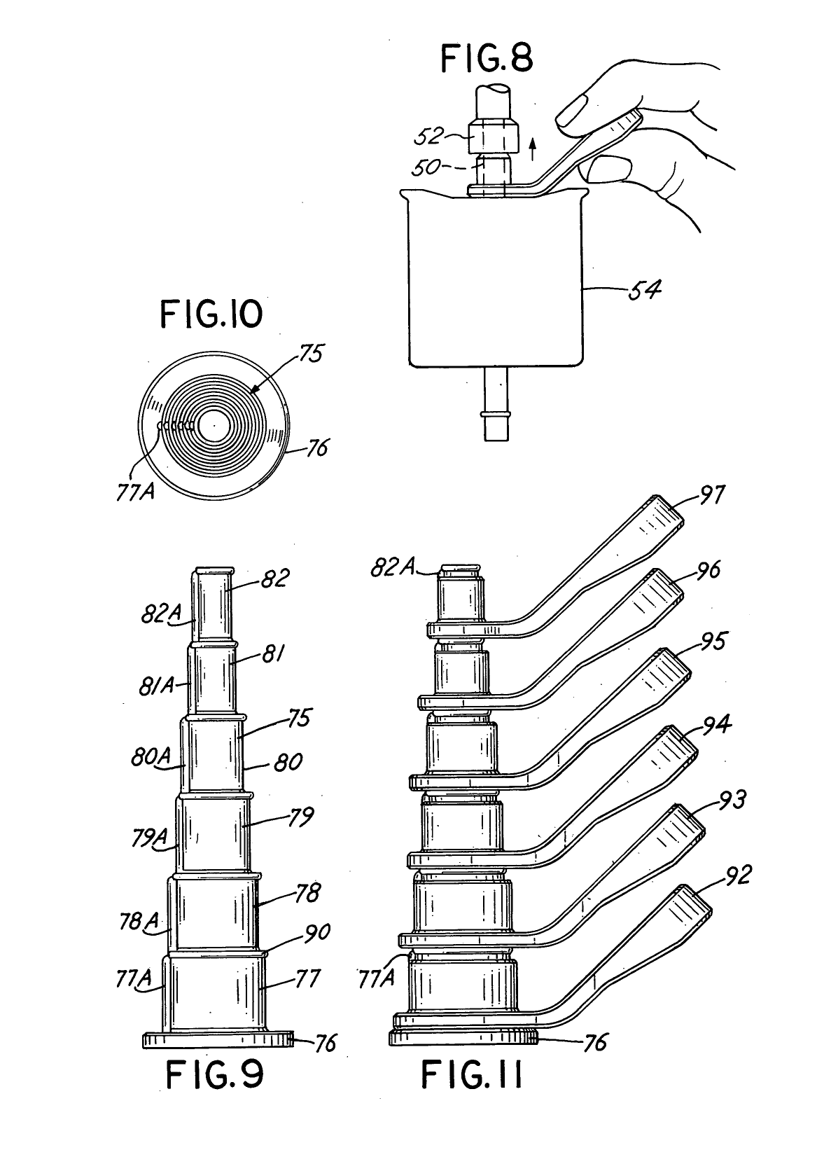

Each of the arms 28 and 30 includes second runs or sections 38 and 40 respectively which connect with the first runs 32 and 34 respectively and form an obtuse angle 39 therewith. The runs 38 and 40 are joined by an arcuate, connecting, elastomeric, integrally molded ring or annular sector 42. The connecting annular sector 42 defines a generally cylindrical passage 44. The annular sector 42 has a spring constant which enables the arms 28 and 30 to be maintained in a spread-apart condition, but manually flexed one toward the other when the tool is in use. Additionally, the cylindrical passage 44 is sized to permit manual gripping, for example, by placement of a finger therethrough to facilitate the utilization of the tool as depicted in FIG. 8.

The runs 32, 34 terminate at the end of the tool to define a linear slot with spaced, opposed, outward flared surfaces 31, 33. Surfaces 31, 33 are flared and divergent to facilitate separation and placement of the spaced sections 20, 22 over a tube (50 in FIG. 8) and thus initially cause elastic spreading of the arms 28, 30. Once placed over a tube, the elastically annular sector 42 biases the arms 28, 30 together in position toward one another as semi cylindrical sectors 20, 22 fit over tubing. In the relaxed condition of the tool, the arms 28 and 30 are slightly spaced one from the other and may be manually moved toward one another so that the semi-cylindrical sections 20 and 22 are appropriately positioned about tubing to then effect disengagement of a coupling. The arms 28, 30 and attached elements are thus generally mirror images of each other joined by the elastic arcuate sector 42.

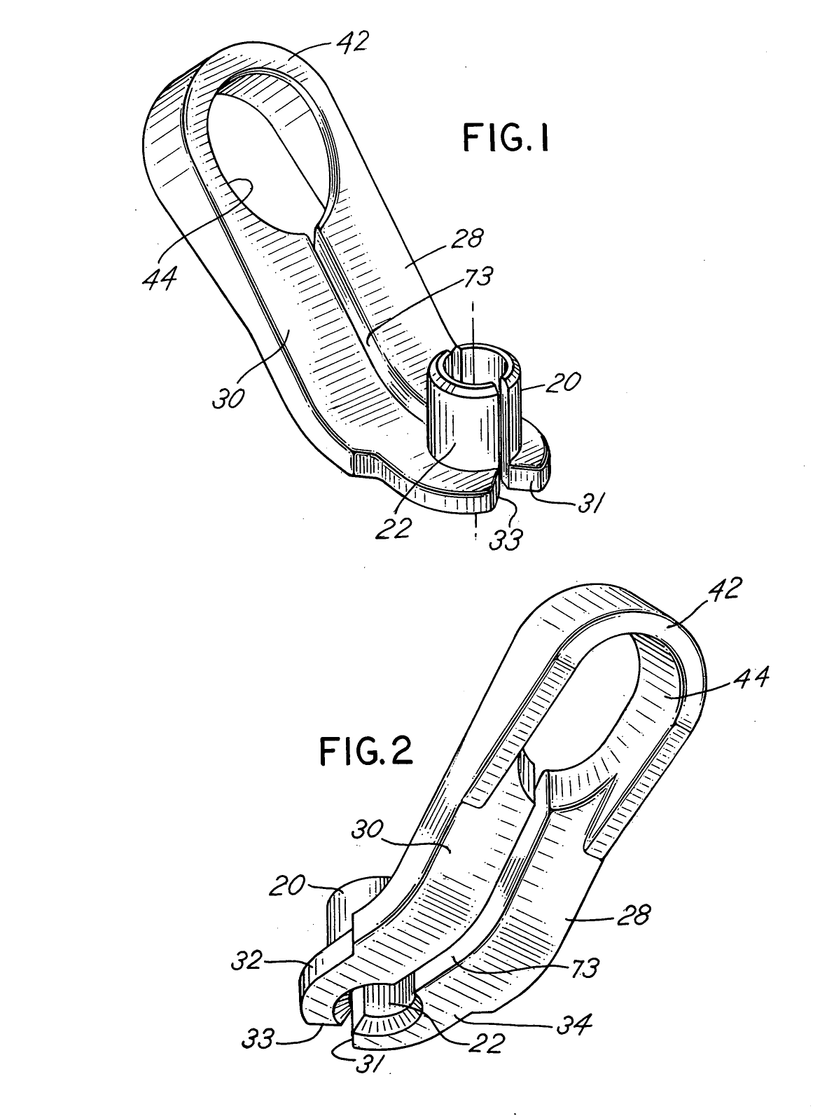

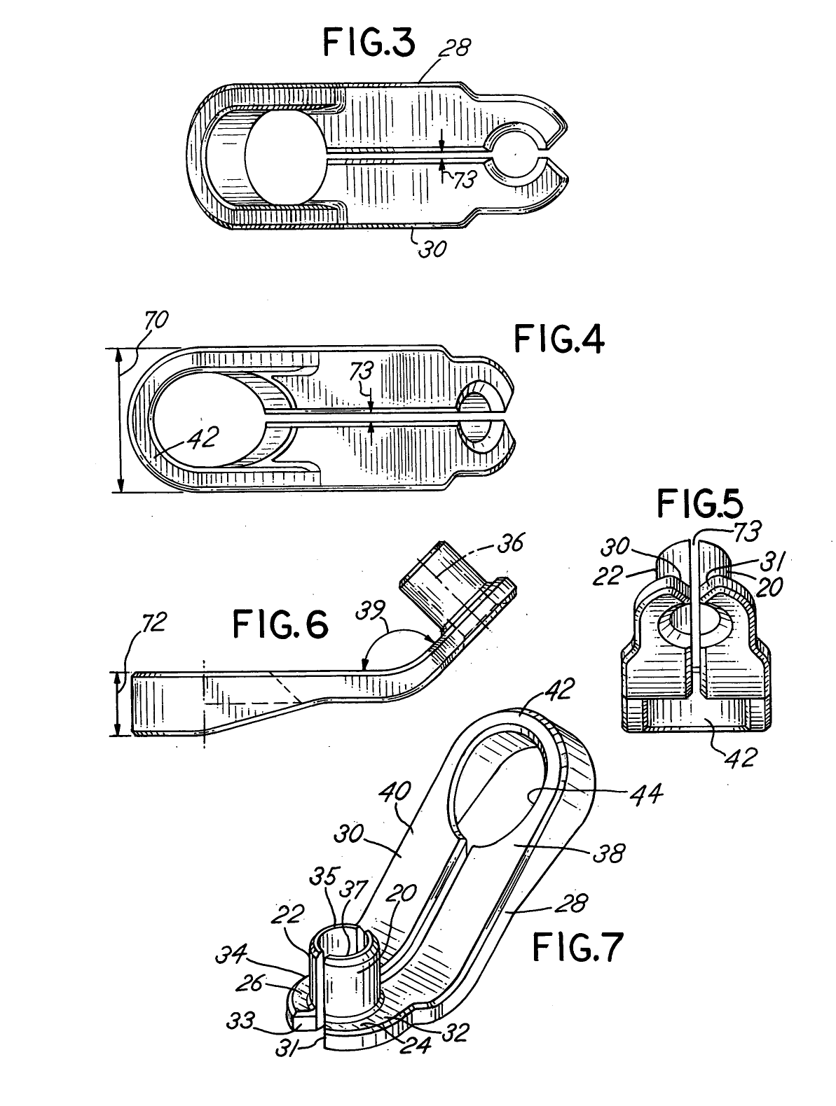

Among the beneficial aspects of the invention relative to the prior art is the fact that the arms 28 and 30 are maintained at a fixed distance from one another but may be easily spread to enable placement of the semi-cylindrical sectors 20 and 22 about tubing 50. This is a result of the flexure built into the tool as a result of the annular or arcuate sector 42. The arms 28 and 30 may thus be maintained at their rest position, for example, as illustrated in FIG. 1, but may be moved from that rest position to accommodate use of the tool by placement on tubing. The various dimensions associated with the sector 42 including the thickness and the depth and the length thereof may be adjusted to accommodate the elastic forces required to separate the arms 28 and 30 and to move the arms 28 and 30 one toward the other. Thus, the tool may incorporate by design the ability to be highly adjustable depending upon the size of the tubing involved, the spacing of arms 28, 30 and other factors associated with the use of the tool. Additionally, the plastic material utilized to make the tool may employ a color coding. That is, different sizes of tools may have a code associated or correlated with the size of tubing.

The arcuate sector 42, in the preferred embodiment, is substantially identical regardless of the diameter size for which the tool is to be used. Thus, for example, a set of six (6) tools, each tool being designed for use with a distinct size of tubing will have an arcuate sector 42 and spaced arms 28, 30 which are substantially identical. However, the generally semi-cylindrical sectors 20, 22 may be custom sized for tubing of a distinct diameter. The outer dimension of the spacing of arms 28, 30 and the outer diameter 70 of the arcuate sector or sector 42 are preferably generally identical. In practice with the plastic material heretofore identified for manufacture of the tool, this dimension is in the range of 0.9±0.1 inch and the inside radius of the arcuate sector 42 is about one-third (⅓) of the diameter, i.e., 0.30±0.05 inch. The thickness 72 of the arcuate sector is about 0.4±0.1 inches for the example described.

By maintaining the same size condition for the arcuate sector 42, manipulation of the tool is facilitated regardless of the tubing size involved. That is the thumb and forefinger of a technician (FIG. 8) can be more easily utilized in the situation where the sizing and shape of the arcuate sector is the same and wherein the straight line gap or space 73 between the arms 28, 30 is constant and about 0.1±0.05 in the example given. Thus, the tool has a standard or similar feel regardless of the sizing of the semi-cylindrical sectors 20, 22. This results because the spring constant for the tubing is the same for all of the tools.

In the example given, six (6) distinctly tubing size tools are disclosed. Each tool has substantially the same obtuse angle (about 135°±30°) between the plane of the arms 28, 30 and the plane of the runs 32, 34. Again, such standardization facilitates the efficient use of each of the separate tools.

Referring to FIGS. 9-11, there is depicted a set of six (6) tools and a holder 75 for the tools. The holder 75 comprises a vertical post with a separate generally cylindrical section for receipt of each tool in descending diameter array. Thus, a planar lower rim 76 supports the post and series of six (6) generally cylindrical sections 77, 78, 79, 80, 81, 82 are provided each section being correlated with the effective diameter of the semi-cylindrical sectors 20, 22 of each tool. Each cylindrical sections 77, 78, 79, 80, 81, 82 includes a generally vertical rib 77A, 78A, 79A, 80A, 81A, 82A which fits into the space between the associated semi-cylindrical sectors 20, 22 of each tool so that the tools will maintain the assembled array as depicted in FIG. 11. The tools are also spaced vertically from one another on post by circular ribs sector rib 90 between sections 77, 78. Thus, as depicted in FIG. 11, a first tool 92 designed for use with ⅞ inch tubings will be mounted at the bottom of post 75. Subsequent tools 93, 94, 95, 96, 97 will, for example, be sized to cooperate with ¾ inch, ⅝ inch, ½ inch, ⅜ inch and 5/16 inch tubing.

In practice, a properly sized tool is chosen based on compatibility with the tubing involved. The tool is then manually positioned and manipulated as depicted in FIG. 8. The semi-cylindrical sectors are placed about the tubing and squeezed if necessary. Typically, however, the sectors 20, 22 fit snuggly against the tubing 50. The tool is then lifted into the coupling manually to engage active top ridge sections or members 35, 37 of the tool therewith.

The active ridge or top edge 35, 37 of each head member 22, 20 may thus be manipulated to decouple tubing as shown in FIG. 8 wherein a coupler 52 is engaged to be released from tubing or connector 50 of a fuel filter 54. The thumb and forefinger can be used to grip and manipulate the tool in restricted spaces.

While there has been set forth specific examples of the tool, it is to be understood that the tool construction, kit and invention are to be limited only by the following claims and equivalents thereof.

1. A tube coupler release tool comprising, in combination:
a first elongate, generally straight arm, having an outer connection end and an integral first end section;
said first arm and said first end section forming an included obtuse angle in the range of about 135°±30°;
a second arm with an outer connection end and integral second end section comprising a generally mirror image of the first arm;
said first arm and said second arm outer connection ends joined by an integral generally arcuate, elastic connection member which maintains the arms in opposed, aligned position separated by a generally straight line, linear slit when the tool is in an unbiased, rest condition;
said first and second end sections each including, a generally semi-cylindrical projection section projecting transversely from the plane of said respective end section, said semi-cylindrical sections in opposed relation separated by said slit in the rest condition, said semi-cylindrical sections in combination forming a generally cylindrical shape characterized by an internal diameter for engagement with a tube coupling mechanism to facilitate disengagement of said coupling mechanism;
said connection member characterized by a circular, arcuate configuration having an outer diameter substantially equal to the outer dimension spacing of the first and second arms.

2. The tool of claim 1 in combination with a plurality of tools having distinct sizes of end sections to form a set.

3. The tools of claim 2 in connection with a storage post having a plurality of diametrical sections, each section corresponding to the internal diameter of the cylindrical sections at rest of each tool in the set.

4. The tools of claim 3 wherein the post diametrical sections are separated by a transverse rib.

5. The tools of claim 3 wherein the diametrical sections include a rib aligned with the axis of the storage post for engaging the slot in the tools to hold the tools in alignment on the post.

6. The tools of claim 3 wherein the post diametrical sections are separated by first transverse rib and the sections include a second rib axially aligned with the axis of the storage post for engaging the slit in the tool.

7. The tools of claim 2 wherein each of the tool in the set have a distinct color correlated with a tubing size.

8. The tool of claim 1 wherein the tool comprises a single unitary molded plastic material.

9. The tool of claim 1 wherein the connection member is a uniform thickness partial circular member.

10. A tube coupler release tool comprising, in combination:
a first elongate, generally straight arm with an outer dimension, having an outer connection end and an opposite coupling tool end;
a first generally, planar end section extending from the first arm tool end, said first arm end and said first end section;
a second arm with an outer connection end, an outer dimension, and integral second end section comprising a generally mirror image of the first arm and integral first end section;
said first arm and second arm outer connection ends joined by an integral generally arcuate, elastic connection member which maintains the arms in opposed, aligned position separated by a straight line linear slit when the tool is in an unbiased, rest condition;
said first and second end sections each including an opposed, generally semi-cylindrical projection section from the plane of each said end section, said semi-cylindrical sections in opposed relation separated by said slit in the rest condition, said semi-cylindrical sections in combination characterized by an internal diameter for engagement with a tube coupling mechanism to facilitate disengagement of said coupling mechanism, said semi-cylindrical sections further characterized by a cylindrical axis forming a right angle with a plane in the range of about 135±5° with the plane of the first and second straight arms;
said connection member characterized by a circular arcuate configuration having an outer diameter substantially equal to the outer dimension spacing of the first and second arms.

11. The tool of claim 10 in combination with a plurality of tools having the same size connection member and distinct sizes of end sections to form a set.

12. The tools of claim 11 in connection with a storage post having a diametrical section corresponding to the internal diameter of each tool in the set.

13. The tools of claim 12 wherein the post diametrical sections are separated by a rib.

14. The tools of claim 12 wherein the diametrical sections include a rib for engaging the slot in the tool to hold the tool in alignment on the post.

15. The tools of claim 12 wherein the post diametrical sections are separated by first rib and the sections each include a second rib for engaging the slit in the tool.

16. The tools of claim 11 wherein tools in the set have a distinct color correlated with a tubing size.

17. The tool of claim 10 wherein the tool comprises a unitary molded plastic material.

18. The tool of claim 10 wherein the connection member is a uniform thickness, partial circular member.

19. A tube coupler release tool comprising, in combination:
a first elongate, generally straight arm with an outer dimension, having an outer connection end and an opposite coupling tool end;
a first generally, planar end section extending from the first arm tool end, said first arm end and said first end section forming an included obtuse angle;
a second arm with an outer connection end, an outer dimension, and integral second end section comprising a generally mirror image of the first arm and integral first end section;
said first arm and second arm outer connection ends joined by an integral generally arcuate, elastic connection member which maintains the arms in opposed, aligned position separated by a straight line linear slit when the tool is in an unbiased, rest condition;
said first and second end sections each including an opposed, generally semi-cylindrical projection section from the plane of each said end section, said semi-cylindrical sections in opposed relation separated by said slit in the rest condition, said semi-cylindrical sections in combination characterized by an internal diameter for engagement with a tube coupling mechanism to facilitate disengagement of said coupling mechanism;
said connection member characterized by a circular arcuate configuration having an outer diameter substantially equal to the outer dimension spacing of the first and second arms.

20. The tool of claim 9 wherein the connection member has a thickness in the range of about 0.4±0.1 inches.
